(19) United States
(12) Patent Application Publication
(10) Pub. No.: US 2020/0082272 A1
(43) Pub. Date: Mar. 12, 2020

(54) Enhancing Data Privacy in Remote Deep Learning Services

(71) Applicant: International Business Machines Corporation, Armonk, NY (US)

(72) Inventors: Zhongshu Gu, Ridgewood, NJ (US); Heqing Huang, Mahwah, NJ (US); Jialong Zhang, San Jose, CA (US); Cao Xiao, Cambridge, MA (US); Tengfei Ma, White Plains, NY (US); Dimitrios Pendarakis, Westport, CT (US); Ian M. Molloy, Chappaqua, NY (US)

(21) Appl. No.: 16/127,356

(22) Filed: Sep. 11, 2018

(51) Int. Cl. G06N 3/08; G06F 21/62; G06F 17/30

(52) U.S. Cl. CPC G06N 3/088; G06F 17/3028; G06F 17/30271; G06F 21/6245

(57) ABSTRACT

Mechanisms are provided for executing a trained deep learning (DL) model. The mechanisms receive, from a trained autoencoder executing on a client computing device, one or more intermediate representation (IR) data structures corresponding to training input data input to the trained autoencoder. The mechanisms train the DL model to generate a correct output based on the IR data structures from the trained autoencoder, to thereby generate a trained DL model. The mechanisms receive, from the trained autoencoder executing on the client computing device, a new IR data structure corresponding to new input data input to the trained autoencoder. The mechanisms input the new IR data structure to the trained DL model executing on the deep learning service computing system, to generate output results for the new IR data structure. The mechanisms generate an output response based on the output results, which is transmitted to the client computing device.

### BACKGROUND

The present application relates generally to an improved data processing apparatus and method and more specifically to mechanisms for enhancing data privacy in remotely located deep learning services, such as deep learning cloud services, for example.

Deep learning systems have been widely deployed as part of artificial intelligence (AI) services due to their ability to approach human performance when performing cognitive tasks. Deep learning is a class of machine learning technology that uses a cascade of multiple layers of nonlinear processing units for feature extraction and transformation. Each successive layer uses the output from the previous layer of input. The deep learning system is trained using supervised, e.g., classification, and/or unsupervised, e.g., pattern analysis, learning mechanisms. The learning may be performed with regard to multiple levels of representations that correspond to different levels of abstraction, with the levels forming a hierarchy of concepts.

Most modern deep learning models are based on an artificial neural network, although they can also include propositional formulas or latent variables organized layer-wise in deep generative models such as the nodes in Deep Belief Networks and Deep Boltzmann Machines. In deep learning, each level learns to transform its input data into a slightly more abstract and composite representation. In an facial image recognition application, for example, the raw input may be a matrix of pixels with the first representational layer abstracting the pixels and encoding edges, the second layer composing and encoding arrangements of edges, the third layer encoding a nose and eyes, and the fourth layer recognizing that the image contains a face. Importantly, a deep learning process can learn which features to optimally place in which level on its own, but this does not completely obviate the need for hand-tuning. For example, hand tuning may be used to vary the number of layers and layer sizes so as to provide different degrees of abstraction.

The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs is that of the network and is the number of hidden layers plus one (as the output layer is also parameterized). For recurrent neural networks, in which a signal may propagate through a layer more than once, the CAP depth is potentially unlimited. No universally agreed upon threshold of depth divides shallow learning from deep learning, but most researchers agree that deep learning involves a CAP depth greater than 2. CAP of depth 2 has been shown to be a universal approximator in the sense that it can emulate any function. Beyond that, more layers do not add to the function approximator ability of the network, but the extra layers help in learning features.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided for executing a deep learning (DL) model on a deep learning service computing system. The method comprises receiving, by the deep learning service computing system, from a trained autoencoder executing on a client computing device, one or more intermediate representation (IR) data structures corresponding to training input data input to the trained autoencoder. The method further comprises training the DL model, executing on the deep learning service computing system, to generate a correct output based on the IR data structures from the trained autoencoder, to thereby generate a trained DL model. Moreover, the method comprises receiving, by the deep learning service computing system, from the trained autoencoder executing on the client computing device, a new IR data structure corresponding to new input data input to the trained autoencoder. In addition, the method comprises inputting the new IR data structure to the trained DL model executing on the deep learning service computing system, to generate output results for the new IR data structure. Furthermore, the method comprises generating, by the deep learning computing system, an output response based on the output results, which is transmitted to the client computing device.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example block diagram illustrating an interaction of the primary operational components of one illustrative embodiment;

FIG. 2 depicts a pictorial representation of an example distributed data processing system in which aspects of the illustrative embodiments may be implemented;

FIG. 3 is a block diagram of just one example data processing system in which aspects of the illustrative embodiments may be implemented;

FIG. 4 is a flowchart outlining an example operation for training and utilizing a deep learning cloud computing service in accordance with one illustrative embodiment;

FIG. 5 depicts a cloud computing environment according to an embodiment of the present invention; and

FIG. 6 depicts abstraction model layers according to an embodiment of the present invention.

### DETAILED DESCRIPTION

While deep learning, or artificial intelligence (AI), systems and services utilize deep learning systems as part of their backend engines, concerns still exist regarding the confidentiality of the end users' provisioned input data, even for those reputable deep learning or AI service providers. That is, there is concern that accidental disclosure of sensitive user data might unexpectedly happen due to security breaches, exploited vulnerabilities, neglect, or insiders.

Deep learning, or AI, cloud providers generally offer two independent deep learning (DL) services, i.e., training and inference. End users can build, via training application programming interfaces (APIs), customized DL models for their particular tasks from scratch by feeding training services with their own training data which then train specific learning models based on the input training data. In cases where the end users do not possess enough training data, they can also leverage transfer learning techniques to repurpose and retrain existing models targeting similar tasks. After obtaining their trained models, end users can upload the models, which are in the form of hyperparameters and weights of deep neural networks (DNNs), to inference services (which might be hosted by different AI service providers than those providing the training services) to bootstrap their AI cloud application programming interfaces (APIs). These inference APIs can be further integrated into mobile or desktop applications. At runtime, end users can invoke the remote inference APIs with their input data to thereby query the remote deep learning services, which are backed by their own trained learning models or by some general learning models that are pre-trained by the providers, and receive prediction results from the inference services.

Although end users always expect that service providers should be trustworthy and dependable, they may still have some concerns about the data privacy of their inputs. Accidental disclosures of confidential data might unexpectedly occur due to malicious attacks, mis-operations by negligent system administrators, or data thefts conducted by insiders. Adversaries with escalated privileges may be able to extract sensitive data from disks (data-at-rest) or from main memory (runtime data). Numerous data breaches of these types have been observed in recent years. Similar incidents can also happen to user input data for AI cloud services. In addition, deep learning is often differentiated by processing raw input data, such as images, audio, and video, as opposed to hand-crafted features. This poses more privacy concerns if the input data is leaked or compromised.

For example, in an image recognition application scenario, users may be concerned about uploading their raw images to deep learning cloud services. On one hand, the users want to leverage the deep learning services to automate the process of interpreting and extracting semantic information from the images. However, on the other hand, the users have privacy concerns about the final destinations of their raw images even if the deep learning services provider is trustworthy. In the best scenario, the input images can be securely deleted from the deep learning services provider's storage after being processed by the deep learning service. However, mistakes of mishandling raw image data could happen at any time and in every procedure of the deep learning service. In some cases, adversaries may exploit system vulnerabilities or conduct phishing attacks on the deep learning service administrators to steal raw input image data. Moreover, forensics experts are able to recover or reconstruct raw input data from the residual data left on the storage devices or in the computer memory. Thus, security of user input data during both training and inference tasks with a remotely located deep learning service, are of considerable concern in modern society.

The illustrative embodiments provide a privacy enhancing mechanism to mitigate sensitive information disclosure in deep learning systems, also sometimes referred to as deep learning inference pipelines. With the mechanisms of the illustrative embodiments, rather than requiring a user upload raw input data, e.g., raw input image data, to a remote deep learning service computing system, the raw input data is transformed/encoded into an intermediate representation at the client-side computing device using a client-side autoencoder. The remotely located deep learning service's instance of a deep learning (DL) model for the user, e.g., a DL neural network, is trained using the intermediate representation of the raw input data. Thereafter, during runtime inference generation using the remotely located deep learning service and the trained DL model, the client-side autoencoder is again used to generate intermediate representations of the input data which are then transmitted to the remotely located DL service which operates on the intermediate representations and provides the correct resulting output back to the client computing device.

Thus, with the mechanisms of the illustrative embodiments, the raw input data is never transmitted to the remotely located deep learning service computing systems, whether during training or during runtime processing of input data. As a result, the raw input data is never placed in a position outside the control of the owner of the raw input data, such that access to the raw input data may be intentionally or unintentionally provided to potential adversaries. Moreover, even if the intermediate representations of the raw input data are leaked or accessed by adversaries, the adversaries will not be able to recover the raw input data without knowledge of the encoding and decoding procedures of the client-side autoencoder, which are kept secret at the user's client side computing device. These mechanisms may also diminish the impact of model inversion attacks and membership inference attacks, as the recovered/inferred input data themselves is incomprehensible to the adversary without knowledge of the specific training of the autoencoder and the particular way that the intermediate representation is generated by the trained autoencoder.

Before beginning the discussion of the various aspects of the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular implementation for accomplishing and/or performing the actions, steps, processes, etc., attributable to and/or performed by the engine. An engine may be, but is not limited to, software, hardware and/or firmware or any combination thereof that performs the specified functions including, but not limited to, any use of a general and/or specialized processor in combination with appropriate software loaded or stored in a machine readable memory and executed by the processor. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

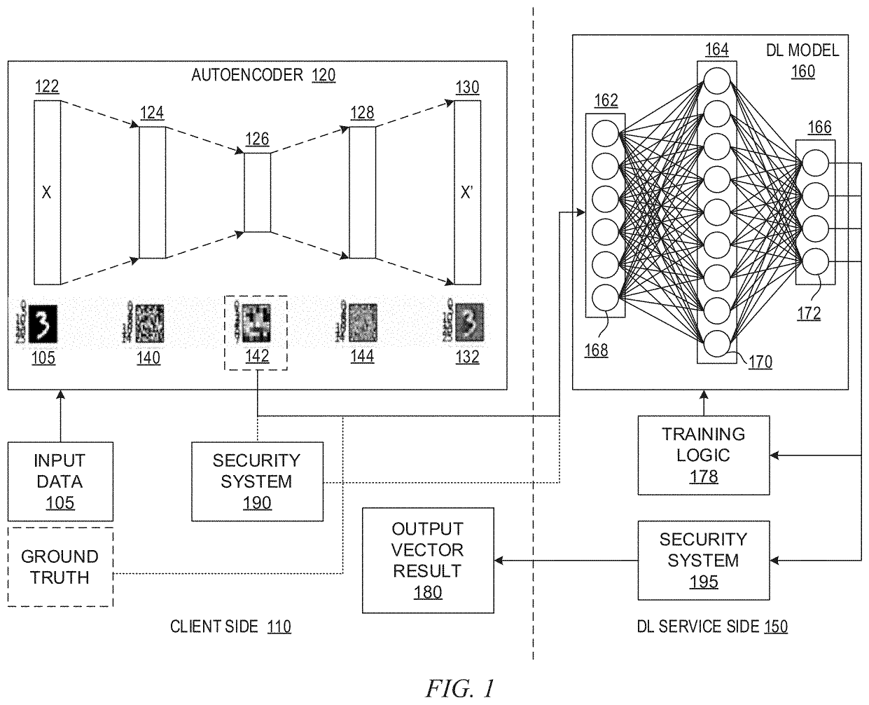

FIG. 1 is an example block diagram illustrating an interaction of the primary operational components of one illustrative embodiment. As shown in FIG. 1, the operation of the illustrative embodiment is split between a client side 110 operation and a deep learning (DL) service side 150 operation, where the client side 110 operation is executed on one or more client computing devices (not shown) and the DL service side 150 operation is executed on one or more server computing devices (not shown). The transmission of data between the client side 110 and the DL service side 150 is facilitated by one or more data communication networks (not shown) which may be wired, wireless, or any combination of wired and wireless data communication networks.

Also as shown in FIG. 1, the client side 110 operation involves the execution of an autoencoder 120 on raw input data 105 to generate an output vector. The DL service 150 operation involves the execution of a DL model 160 on data generated by the autoencoder 120 to thereby train and/or perform runtime inference operations on the data generated by the autoencoder 120 to generate an output 180, as discussed in greater detail hereafter.

In one illustrative embodiment, the client-side autoencoder 120 is a neural network, as shown, executing on one or more client-side computing devices (not shown). The autoencoder 120 is trained using raw input data 105 at the client-side computing devices. The client-side autoencoder 120 has an input layer 122 of neurons, or “nodes,” one or more intermediate layers 124-128 of neurons or nodes, and an output layer 130 of neurons or nodes that is a same size as the input layer 122. The autoencoder 120 is trained using an unsupervised training operation that minimizes the loss between the input and output and thus, the output layer 130 should have a same layout and similar content as the input layer 122. The size of the intermediate layers 124-128 may be implementation specific, i.e. may have different sizes depending on the desired implementation. Because the training is unsupervised, the input to the autoencoder 120 during training does not require a ground truth label set for the training to be performed, as the training achieves a minimum loss between the input and the output.

Thus, the raw input data X 105, e.g., raw training data, is input to the autoencoder 120 whose characteristics are such that the autoencoder 120 neural network will minimize the difference between the input X 105 and output X′ 132 through a forward propagation, backpropagation and weight updating based training process. That is, weights associated with nodes in one or more of the intermediate layers 124-128 are adjusted in an iterative training process so that the difference between the raw input data 105 and the output 132 generated by the autoencoder 120 is minimized, and thus, consequently the output 132 can reconstruct the input data 105. A first portion of the intermediate layers 124-126 extract features from their inputs which result in a smaller size or “flattened” feature vector at each of the intermediate layers 124-126, which is then expanded by subsequent intermediate layers 128 and the output layer 130 to generate an output result 132 having a same size as the input layer 122 to facilitate comparison of the output 132 with the original input data 105. In other words, some intermediate layers 124-126 encode the original input data 105 to generate intermediate representations (IRs) 140-142, while subsequent intermediate layers 128-230 decode the IR 142 to generate expanded IRs 144 and ultimately the output 132. Thus, the output X′ 132 of the autoencoder 120 is an approximation of the input data X 105 after having gone through a plurality of intermediate layers 124-128 that extract features of the input data X 105 and generate intermediate representations (IRs) 140-144. It should be appreciated that the configuration of the autoencoder 120 in FIG. 1 is only an example and the configuration may vary depending on the desired implementation. For example, more or fewer layers may be provided in the autoencoder 120 than that shown in FIG. 1 and the layers may have any of a variety of different sizes.

The trained autoencoder 120 is then used to generate IRs 142 for input data 105 (input training data during the training phase) which are used to train the remotely located DL model 160 for the user, e.g., a DL neural network 160, executing on one or more remotely located computing devices associated with a DL service provider, e.g., a DL cloud service provider, on the DL service side 150. That is, the training data 105 is input to the trained autoencoder 120 at the client side 110, where the trained autoencoder 120 generates one or more IRs 140-142 corresponding to the input data. A selected IR, such as the IR generated by the intermediate layer 126 just prior to the decoding intermediate layer 128, i.e., the last encoding intermediate layer, is transmitted as training data input to the remotely located DL service provider computing systems (at the DL service side 150) and used as training input to the remotely located DL model 160. Because this is a supervised training operation, the training input may further include a ground truth for the corresponding training input, such as a correct label indicating the proper class or category output that should be generated by an appropriately trained DL model 160, e.g., the training input may be in the format of (142, “3”) where 142 is the IR and “3” is the label for this IR. For purposes of the following description, it will be assumed that the remotely located DL service provider is a DL cloud service provider comprising a plurality of server computing devices that together operate as a “cloud service,” although cloud services is not a required framework for the operation of the present invention and any client-server type architecture may make use of the mechanisms of the illustrative embodiments without departing from the spirit and scope of the illustrative embodiments.

The DL model 160 at the DL cloud service provider computing system, which again may comprise one or more server computing devices facilitating the training and inference operation of the DL model 160, is trained using the selected IR as the input training data for the DL model 160. The DL model 160, as shown in FIG. 1, may be implemented as a deep learning neural network model 160 having an input layer 162 comprising a plurality of input layer neurons or nodes 168, one or more intermediate (or “hidden”) layers 164 comprising a plurality of intermediate layer neurons or nodes 170, and an output layer 166 comprising a plurality of output neurons or nodes 172 which together generate an output vector 180 comprising the inference result generated by the DL model 160, e.g., each output neuron or node 172 outputs a corresponding value for a vector slot of the output vector 180. For example, in an image analysis application of the DL model 160, the DL model 160 may process input data representing an input image, and generate an output vector that categorizes the input image as one of a plurality of different categories of images. For example, the vector output may have a plurality of vector slots, where each vector slot corresponds to a particular predefined category of image. Values stored in the vector slots represent probabilities or confidence scores indicating a probability or confidence that the input image is properly classified into the corresponding class or category of image.

With regard to the illustrative embodiments, the DL model 160 is specifically trained using IRs 142 generated by the client side trained autoencoder 120 based on the input data 105 input to the trained autoencoder 120, and a ground truth or correct label (class or category) for the corresponding IRs. That is, rather than providing the raw input data 105, e.g., a raw input image, to the remotely located DL model 160 as input to the input layer 162, the IR 142 generated by the trained autoencoder 120 is instead provided as the input to the input layer 162 of the DL model 160, along with a correct label or ground truth value. The IRs 142 used to train the DL model 160 may be generated for each input data set 105 input to the trained autoencoder 120 such that an IR set is input to the DL model 160 in an iterative manner to train the DL model 160. That is, similar to the training of the autoencoder 120, the DL model 160 is trained in an iterative manner using forward propagation, backpropagation, and weight updating for weights associated with the intermediate and/or output layer nodes 170, 172, to minimize a loss function of the DL model 160 representing a difference between the generated output vector 180 and the ground truth, also referred to as a correct label, class, or category, associated with the original input data 105, and thus associated with the generated IR(s). That is, with the IRs 142 transmitted to the DL model 160, the ground truth associated with the input data 105 may be provided to the training logic 178 of the DL service 150 computing device(s) to provide a basis for evaluating the training of the DL model 160 and forward propagate, backpropagate and update weights of the nodes so as to minimize the difference between the output 180 and the correct output (ground truth). The training logic 178 orchestrates and controls the operations for evaluating the accuracy of the operation of the DL model 160, e.g., evaluating the loss function of the DL model 160, and training the weights of the nodes of the DL model 160 using forward propagation, backpropagation and weight updating in an iterative manner.

Once the DL model 160 is trained using the IRs generated by the trained autoencoder 120 based on training datasets input to the trained autoencoder 120 as input data 105, the resulting trained DL model 160 may then be used to perform runtime inference operations on new input data to the trained autoencoder 120. That is, new input data, which may be input to the trained autoencoder 120 as input 105, may be provided that is to be processed by the trained DL model 160. The new input data is processed through the trained autoencoder 120 to generate an IR 142 representing the new input data. The generated IR 142 is input to the trained DL model 160 at the remotely located DL service provider's computing system. The trained DL model 160 processes the IR 142 and generates an output 180 that is provided back to the client side 110 processing.

For example, the new input data may be an input image that is to be classified by the trained DL model 160 to classify the image into one of a plurality of image classes or categories, e.g., identifying what object is present in the image, in a medical application identifying a medical image as having an abnormality, a particular type of abnormality, or being normal, or the like. Taking a medical imaging application as an example, the input medical image is input to the trained autoencoder 120 which generates an IR 142 of the input medical image that is output and transmitted to the remotely located trained DL model 160. The trained DL model 160 has been trained to properly classify IRs of medical images into corresponding classes of medical images, e.g., abnormal, normal, etc. The trained DL model 160 receives the IR 142 for the medical image, processes it to generate the output vector 180 specifying the classification of the medical image, and provides the output vector 180 back to the client side 110 as a result of the trained DL model 160 processing of the medical image.

It should be appreciated that while the trained DL model 160 provides the correct vector output 180 back to the client side 110 processes, at no time is the original input data transmitted outside the client side 110 to the remotely located DL service computing system at the DL service 150 side. This is true both during the training of the DL model 160 and during runtime inference processing of new input data after the DL model 160 has been trained. Thus, the raw input data is maintained at the client computing devices and under the owner's control, thereby providing the owner with the assurance that their raw input data is maintained secure according to their own client side security mechanisms, while still being able to take advantage of the resources of the remotely located DL model 160, e.g., a DL cloud service and its corresponding computing resources. Furthermore, as the raw input data is not exposed outside the client side 110, and the training of the autoencoder 120 is not exposed outside the client side 110, the ability of an attacker to deduce the raw input data is greatly diminished. Thus, even if the attacker is able to obtain the IRs, the attacker is not able to recreate the original input data without a knowledge of the autoencoder 120.

In some illustrative embodiments, the IRs 142, i.e. the encoded input data, may themselves be encrypted prior to transmission to the DL services computing system. A security system 190 may be provided on the client side 110 for establishing a secure communication channel with the DL service side 150 security system 195, and perform encryption/decryption the IRs and/or output vector results 180 generated by the trained DL model 160. That is, the security system 190 may be used to encrypt the IRs, ground truth data, and any other data transmitted from the client side 110 processes to the DL services computing systems at the DL service side 150. The security system 195 may decrypt these IRs, ground truth data, and any other data received from the client side 110 processes for processing at the DL services side 150 processes. Similarly, the security system 195 may encrypt the output vector results 180 that are transmitted back to the client side 110 processes, which may then be decrypted by the client side security system 190. This provides an additional measure of security of the IRs against unwanted access by a would-be attacker.

Thus, the illustrative embodiments provide a mechanism for permitting users of client devices to take advantage of remotely located deep learning services, e.g., model training services and model inference processing services, which may be provided by a remotely located deep learning services provider, such as a cloud services provider. The illustrative embodiments provide these mechanisms such that the user's raw input data is not exposed to entities outside of the user's own client computing devices, thereby maintaining the security of the user's raw input data at the client computing devices and the security mechanisms that the user has implemented at the client side. Thus, the user is given the assurance that they are in control of their own raw input data while still being able to make use of the computing power and resources of a remotely located deep learning services provider computing system, such as a deep learning cloud services computing system that may provide the computing resources of a plurality of server computing systems. The mechanisms of the illustrative embodiments achieve these benefits by utilizing a client side autoencoder 120 whose training is maintained at the client side and is not exposed outside the client side computing device(s). The trained autoencoder 120 then provides intermediate representations (IRs) of the raw input data, rather than the raw input data itself, to the remotely located DL model 160 for training/processing. Thus, the raw input data is not transmitted outside the client computing devices and is not maintained in any storage at the remotely located DL model 160 or the DL services computing system(s).

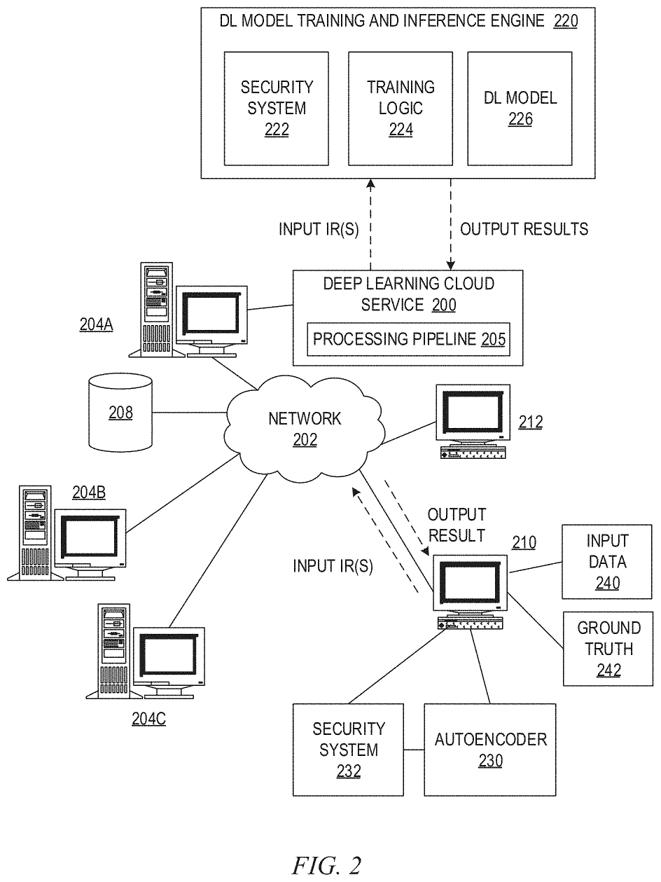

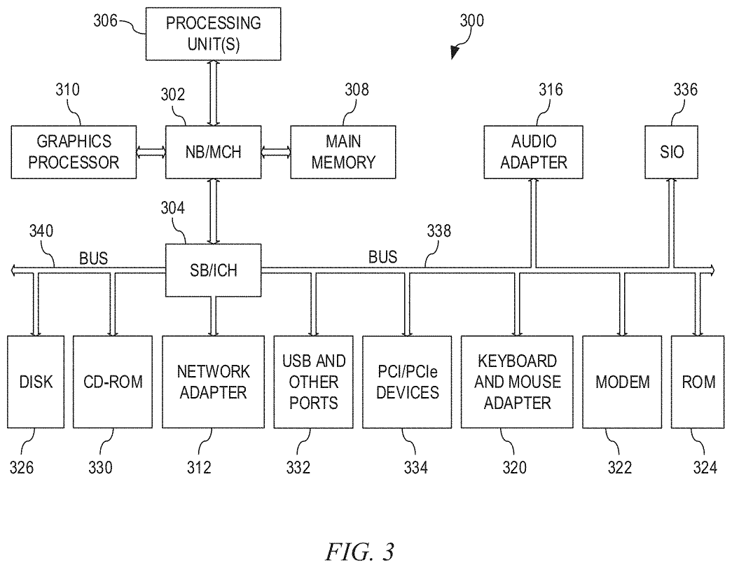

As is apparent from the above description, the present invention provides a computer tool for improving the privacy of input data to a remotely located deep learning system. Thus, the illustrative embodiments may be utilized in many different types of data processing environments. In order to provide a context for the description of the specific elements and functionality of the illustrative embodiments, FIGS. 2 and 3 are provided hereafter as example environments in which aspects of the illustrative embodiments may be implemented. It should be appreciated that FIGS. 2 and 3 are only examples and are not intended to assert or imply any limitation with regard to the environments in which aspects or embodiments of the present invention may be implemented. Many modifications to the depicted environments may be made without departing from the spirit and scope of the present invention.

FIG. 2 depicts a pictorial representation of an example distributed data processing system in which aspects of the illustrative embodiments may be implemented. Distributed data processing system 200 may include a network of computers in which aspects of the illustrative embodiments may be implemented. The distributed data processing system 200 contains at least one network 202, which is the medium used to provide communication links between various devices and computers connected together within distributed data processing system 200. The network 202 may include connections, such as wire, wireless communication links, satellite communication links, fiber optic cables, or the like.

In the depicted example, servers 204A-204C are connected to network 202 along with storage unit 208. In addition, clients 210 and 212 are also connected to network 202. These clients 210 and 212 may be, for example, personal computers, network computers, or the like. In the depicted example, servers 204A-204C provide data, such as boot files, operating system images, and applications to the clients 210-212. Clients 210-212 are clients to a cloud computing system comprising server 204A, and possibly one or more of the other server computing devices 204B-204C, in the depicted example. Distributed data processing system 200 may include additional servers, clients, and other computing, data storage, and communication devices not shown.

In the depicted example, distributed data processing system 200 is the Internet with network 202 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 200 may also be implemented to include a number of different types of networks, such as for example, an intranet, a local area network (LAN), a wide area network (WAN), or the like. As stated above, FIG. 2 is intended as an example, not as an architectural limitation for different embodiments of the present invention, and therefore, the particular elements shown in FIG. 2 should not be considered limiting with regard to the environments in which the illustrative embodiments of the present invention may be implemented.

As shown in FIG. 2, one or more of the computing devices, e.g., server 204A, may be specifically configured to implement a deep learning cloud service 200 which further implements a deep learning (DL) model training and inference engine 220, in accordance with one illustrative embodiment. Moreover, one or more of the client computing devices, e.g., client computing device 210, may be specifically configured to implement an autoencoder 230 and corresponding training logic for training the autoencoder 230 to generate intermediate representations (IRs) of input data 240. The configuring of the computing devices may comprise the providing of application specific hardware, firmware, or the like to facilitate the performance of the operations and generation of the outputs described herein with regard to the illustrative embodiments. The configuring of the computing devices may also, or alternatively, comprise the providing of software applications stored in one or more storage devices and loaded into memory of a computing device, such as server 204A, client computing device 210, or the like, for causing one or more hardware processors of the computing devices to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing devices are configured in one of these ways, the computing devices become specialized computing devices specifically configured to implement the mechanisms of the illustrative embodiments and are not general purpose computing devices. Moreover, as described hereafter, the implementation of the mechanisms of the illustrative embodiments improves the functionality of the computing devices and provides a useful and concrete result that facilitates enhanced data and model privacy when using a remotely located deep learning model and/or deep learning service, such as a deep learning cloud service and corresponding deep learning model implemented as a neural network, e.g., a deep neural network (DNN).

As shown in FIG. 2, one or more of the servers 204A-204C are configured to implement the deep learning cloud service 200 and deep learning (DL) model training and inference engine 220. While FIG. 2 shows elements 200 and 220 being associated with a single server, i.e. server 204A, it should be appreciated that a plurality of servers, e.g., 204A-204C, may together constitute a cloud computing system and be configured to provide the deep learning cloud service 200 implementing the DL model training and inference engine 220 such that the mechanisms of the deep learning cloud service 200, including the engine 220, or portions thereof, and the processing pipeline(s) 205 or portions thereof, may be distributed across multiple server computing devices 204A-204C. In some illustrative embodiments, multiple instances of the deep learning cloud service 200, pipeline(s) 205, and engine 220 may be provided on multiple different servers 204A-204C of the cloud computing system. The deep learning cloud service 200 may provide any deep learning or AI based functionality of a deep learning system, an overview of which, and examples of which, are provided hereafter.

In some illustrative embodiments, the deep learning cloud service 200 may implement a cognitive computing system, or cognitive system. As an overview, a cognitive system is a specialized computer system, or set of computer systems, configured with hardware and/or software logic (in combination with hardware logic upon which the software executes) to emulate human cognitive functions. These cognitive systems apply human-like characteristics to conveying and manipulating ideas which, when combined with the inherent strengths of digital computing, can solve problems with high accuracy and resilience on a large scale. A cognitive system performs one or more computer-implemented cognitive operations that approximate a human thought process as well as enable people and machines to interact in a more natural manner so as to extend and magnify human expertise and cognition. A cognitive system comprises artificial intelligence logic, such as natural language processing (NLP) based logic, image analysis and classification logic, electronic medical record analysis logic, etc., for example, and machine learning logic, which may be provided as specialized hardware, software executed on hardware, or any combination of specialized hardware and software executed on hardware. The logic of the cognitive system implements the cognitive operation(s), examples of which include, but are not limited to, question answering, identification of related concepts within different portions of content in a corpus, image analysis and classification operations, intelligent search algorithms such as Internet web page searches, for example, medical diagnostic and treatment recommendations and other types of recommendation generation, e.g., items of interest to a particular user, potential new contact recommendations, or the like.

IBM Watson is an example of one such cognitive system which can process human readable language and identify inferences between text passages with human-like high accuracy at speeds far faster than human beings and on a larger scale. In general, such cognitive systems are able to perform the following functions: navigate the complexities of human language and understanding; Ingest and process vast amounts of structured and unstructured data; generate and evaluate hypothesis; weigh and evaluate responses that are based only on relevant evidence; provide situation-specific advice, insights, and guidance; improve knowledge and learn with each iteration and interaction through machine learning processes; enable decision making at the point of impact (contextual guidance); scale in proportion to the task; Extend and magnify human expertise and cognition; identify resonating, human-like attributes and traits from natural language; deduce various language specific or agnostic attributes from natural language; high degree of relevant recollection from data points (images, text, voice) (memorization and recall); predict and sense with situational awareness that mimic human cognition based on experiences; and answer questions based on natural language and specific evidence.

In one illustrative embodiment, a cognitive system, which may be implemented as a cognitive cloud service 200, provides mechanisms for answering questions or processing requests from client computing devices, such as client computing device 210, via one or more processing pipelines 205. It should be appreciated that while a single pipeline 205 is shown in FIG. 2, the present invention is not limited to such, and a plurality of processing pipelines may be provided. In such embodiments, the processing pipelines may be separately configured to apply different processing to inputs, operate on different domains of content from one or more different corpora of information from various sources, such as network data storage 208, be configured with different analysis or reasoning algorithms, also referred to as annotators, and the like. The pipeline 205 may process questions/requests that are posed in either natural language or as structured queries/requests in accordance with the desired implementation.

The pipeline 205 is an artificial intelligence application executing on data processing hardware that answers questions pertaining to a given subject-matter domain presented in natural language or processes requests to perform a cognitive operation on input data which may be presented in natural language or as a structured request/query. The pipeline 205 receives inputs from various sources including input over a network, a corpus of electronic documents or other data, data from a content creator, information from one or more content users, and other such inputs from other possible sources of input. Data storage devices, such as data storage 208, for example, store the corpus or corpora of data. A content creator creates content in a document for use as part of a corpus or corpora of data with the pipeline 205. The document may include any file, text, article, or source of data for use in the cognitive system, i.e. the cognitive cloud service 200. For example, a pipeline 205 accesses a body of knowledge about the domain, or subject matter area, e.g., financial domain, medical domain, legal domain, image analysis domain, etc., where the body of knowledge (knowledgebase) can be organized in a variety of configurations, e.g., a structured repository of domain-specific information, such as ontologies, or unstructured data related to the domain, or a collection of natural language documents about the domain.

In operation, the pipeline 205 receives an input question/request, parses the question/request to extract the major features of the question/request, uses the extracted features to formulate queries, and then applies those queries to the corpus of data. Based on the application of the queries to the corpus of data, the pipeline 205 generates a set of hypotheses, or candidate answers/results to the input question/request, by looking across the corpus of data for portions of the corpus of data that have some potential for containing a valuable response to the input question/request. The pipeline 205 performs deep analysis on the input question/request and the portions of the corpus of data found during the application of the queries using a variety of reasoning algorithms. There may be hundreds or even thousands of reasoning algorithms applied, each of which performs different analysis, e.g., comparisons, natural language analysis, lexical analysis, image analysis, or the like, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity. Still further, some reasoning algorithms may perform image analysis so as to classify images into one of a plurality of classes indicating the nature of the image.

The scores obtained from the various reasoning algorithms indicate the extent to which the potential response is inferred by the input question/request based on the specific area of focus of that reasoning algorithm. Each resulting score is then weighted against a statistical model. The statistical model captures how well the reasoning algorithm performed at establishing the inference between two similar inputs for a particular domain during the training period of the pipeline 205. The statistical model is used to summarize a level of confidence that the pipeline 205 has regarding the evidence that the potential response, i.e. candidate answer/result, is inferred by the question/request. This process is repeated for each of the candidate answers/results until the pipeline 205 identifies candidate answers/results that surface as being significantly stronger than others and thus, generates a final answer/result, or ranked set of answers/results, for the input question/request.

As shown in FIG. 2, the deep learning cloud service 200 and its corresponding processing pipeline(s) 205 implements a DL model training and inference engine 220, or simply engine 220. The engine 420 may be invoked by one or more of the reasoning algorithms of the processing pipeline 205 when performing its operations for reasoning over the input question/request and/or processing input data associated with the input question/request. For example, in some illustrative embodiments, the framework 220 may be invoked to assist with classifying input data into one of a plurality of predetermined classes using a deep learning model 226, which may be implemented as a deep neural network (DNN) model, for example. The result generated by the engine 220, e.g., a vector output with probability values associated with each of the predetermined classes to thereby identify a classification of the input data, or simply the final classification itself, may be provided back to the processing pipeline 205 for use in performing other deep learning operations, examples of which have been noted above.

The engine 220 comprises a security system 222, training logic 224, and the DL model or DNN 226. The security system 222 provides the logic for establishing a Transport Layer Security (TLS) connection or other secure communication connection between the server 204A and the client computing device 210, as well as providing encryption/decryption logic for encrypting/decrypting data communicated between the server 204A and the client computing device 210. Similarly, the client computing device 210 may implement a security system 232 to perform similar operations.

The training logic 224 is used to train the DL model 226 for a particular user. It should be appreciated that there may be multiple DL models 226 provided for the same or different users, with each instance of a DL model 226 being hosted by the deep learning cloud service 200 and accessible by the corresponding users after appropriate authentication and attestation via the security system 222. Similarly, separate processing pipelines 205 may be implemented for different users and may be separately configured for implementation for particular purposes for the users. Each user may have one or more pipelines 205 and one or more DL models 226. In the context of the present application, the “users” may be human users, organizations, applications, processes, or any other entity that may make use of the DL cloud services 200 via a client computing device 210.

In operation, a user of a client computing device 210 wishes to utilize the deep learning cloud service 200 to perform a deep learning operation on input data 240, e.g., image analysis and classification using the deep learning cloud service 200. Initially, a client side autoencoder 230 is trained to generate appropriate intermediate representations (IRs) of input data 240. Initially, the input data 240 may be training data that is used to train the autoencoder 230 and the remotely located DL model 226 for the particular user. After training, the input data 240 may be new data for which the user wishes to perform the deep learning operation on this input data 240. The autoencoder 230 is trained to generate correct IRs for the input data 240 as discussed previously above.

The trained autoencoder 230 is then used by to generate IRs for a training dataset 240 to be used to train the remotely located DL model 226. The training dataset 240 is input to the trained autoencoder 230 which generates the corresponding IRs. The IRs and the ground truth labels, i.e. the correct output of a trained DL model, are transmitted to the deep learning cloud service 200 for use in training a DL model 226. This data may be encrypted by the security system 232 prior to transmission, although this is an optional component of the illustrative embodiments.

The IRs are transmitted to the deep learning cloud service 200 via the one or more networks 202, which provides the IRs to the DL model 226 as input, potentially after decryption by the security system 222 in some illustrative embodiments. The DL model 226 processes the IRs with the training logic 224 performing iterative training of the DL model 226 to minimize the loss function, i.e. reduce the error between the output generated by the DL model 226 and the ground truth 242 corresponding to the IRs. The result is a trained DL model 226 that is specifically trained for proper classification of the input data for the particular user. This trained DL model 226 may then be used with a corresponding processing pipeline 205 to process input runtime requests from the client computing device 210 for performing cognitive operations on new input data 240. Alternatively, the trained DL model 226 may provide classification output results directly back to the client computing device 210 without invoking the processing pipeline 205 and cognitive operations of the deep learning cloud service 200.

Thus, after training the DL model 226, new input data 240 may be input to the autoencoder 230 to generate IRs for the new input data 240. These generated IRs may again optionally be encrypted by the security system 232, and transmitted to the deep learning cloud service 200, potentially with a request to perform particular cognitive operations on the IRs, as part of a natural language question or request, or the like. The deep learning cloud service 200 processes the IRs via the trained DL model 226, potentially after decryption via the security system 222, and generates a classification output result that is provided back to the deep learning cloud service 200. The output result may be utilized by the processing pipeline 205 to perform additional cognitive operations with results of the cognitive operations being returned to the client computing device, e.g., answering a question, generating a result of a particular requested operation, or the like, or may be provided back to the client computing device 210 directly for use by processes executing on the client computing device 210.

Again, during this process, the original raw input data 240 is not transmitted to the remotely located deep learning cloud service 200, either during training or during runtime inference operations. Thus, the user of the client computing device 210 is assured that the security of their input data 240 is maintained at the client computing device and the raw input data is not stored at the remotely located deep learning cloud service 200 where the user has less control over how such data would be accessible. Moreover, because the training of the autoencoder 230 is not made available outside the client computing device 210, any interloper or would-be attacker is not apprised of the way in which the trained autoencoder 230 generates the IRs and thus, cannot recreate the input data 240 from the IRs even if they were able to access the IRs. Furthermore, applying encryption mechanisms to the IRs provides an additional level of security.

As noted above, the mechanisms of the illustrative embodiments utilize specifically configured computing devices, or data processing systems, to perform the operations for training and utilizing a remotely located DL model without exposing the raw input data. These computing devices, or data processing systems, may comprise various hardware elements which are specifically configured, either through hardware configuration, software configuration, or a combination of hardware and software configuration, to implement one or more of the systems and/or subsystems described herein. FIG. 3 is a block diagram of just one example data processing system in which aspects of the illustrative embodiments may be implemented. Data processing system 300 is an example of a computer, such as server 204 or client 210 in FIG. 2, in which computer usable code or instructions, logical data structures, and the like, are provided for implementing the processes and aspects of the illustrative embodiments of the present invention as described herein.

In the depicted example, data processing system 300 employs a hub architecture including north bridge and memory controller hub (NB/MCH) 302 and south bridge and input/output (I/O) controller hub (SB/ICH) 304. Processing unit 306, main memory 308, and graphics processor 310 are connected to NB/MCH 302. Graphics processor 310 may be connected to NB/MCH 302 through an accelerated graphics port (AGP).

In the depicted example, local area network (LAN) adapter 312 connects to SB/ICH 304. Audio adapter 316, keyboard and mouse adapter 320, modem 322, read only memory (ROM) 324, hard disk drive (HDD) 326, CD-ROM drive 330, universal serial bus (USB) ports and other communication ports 332, and PCI/PCIe devices 334 connect to SB/ICH 304 through bus 338 and bus 340. PCI/PCIe devices may include, for example, Ethernet adapters, add-in cards, and PC cards for notebook computers. PCI uses a card bus controller, while PCIe does not. ROM 324 may be, for example, a flash basic input/output system (BIOS).

HDD 326 and CD-ROM drive 330 connect to SB/ICH 304 through bus 340. HDD 326 and CD-ROM drive 330 may use, for example, an integrated drive electronics (IDE) or serial advanced technology attachment (SATA) interface. Super I/O (SIO) device 336 may be connected to SB/ICH 304.

An operating system runs on processing unit 306. The operating system coordinates and provides control of various components within the data processing system 300 in FIG. 3. As a client, the operating system may be a commercially available operating system such as Microsoft® Windows 10®. An object-oriented programming system, such as the Java™ programming system, may run in conjunction with the operating system and provides calls to the operating system from Java™ programs or applications executing on data processing system 300.

As a server, data processing system 300 may be, for example, an IBM eServer™ System p computer system, Power™ processor based computer system, or the like, running the Advanced Interactive Executive)(AIX® operating system or the LINUX® operating system. Data processing system 300 may be a symmetric multiprocessor (SMP) system including a plurality of processors in processing unit 306. Alternatively, a single processor system may be employed.

Instructions for the operating system, the object-oriented programming system, and applications or programs are located on storage devices, such as HDD 326, and may be loaded into main memory 308 for execution by processing unit 306. The processes for illustrative embodiments of the present invention may be performed by processing unit 306 using computer usable program code, which may be located in a memory such as, for example, main memory 308, ROM 324, or in one or more peripheral devices 326 and 330, for example.

A bus system, such as bus 338 or bus 340 as shown in FIG. 3, may be comprised of one or more buses. Of course, the bus system may be implemented using any type of communication fabric or architecture that provides for a transfer of data between different components or devices attached to the fabric or architecture. A communication unit, such as modem 322 or network adapter 312 of FIG. 3, may include one or more devices used to transmit and receive data. A memory may be, for example, main memory 308, ROM 324, or a cache such as found in NB/MCH 302 in FIG. 3.

As mentioned above, in some illustrative embodiments the mechanisms of the illustrative embodiments may be implemented as application specific hardware, firmware, or the like, application software stored in a storage device, such as HDD 326 and loaded into memory, such as main memory 308, for executed by one or more hardware processors, such as processing unit 306, or the like. As such, the computing device shown in FIG. 3 becomes specifically configured to implement the mechanisms of the illustrative embodiments and specifically configured to perform the operations and generate the outputs described herein with regard to the deep learning cloud service implementing the privacy enhancing deep learning cloud service framework and one or more processing pipelines.

Those of ordinary skill in the art will appreciate that the hardware in FIGS. 2 and 3 may vary depending on the implementation. Other internal hardware or peripheral devices, such as flash memory, equivalent non-volatile memory, or optical disk drives and the like, may be used in addition to or in place of the hardware depicted in FIGS. 2 and 3. Also, the processes of the illustrative embodiments may be applied to a multiprocessor data processing system, other than the SMP system mentioned previously, without departing from the spirit and scope of the present invention.

Moreover, the data processing system 300 may take the form of any of a number of different data processing systems including client computing devices, server computing devices, a tablet computer, laptop computer, telephone or other communication device, a personal digital assistant (PDA), or the like. In some illustrative examples, data processing system 300 may be a portable computing device that is configured with flash memory to provide non-volatile memory for storing operating system files and/or user-generated data, for example. Essentially, data processing system 300 may be any known or later developed data processing system without architectural limitation.

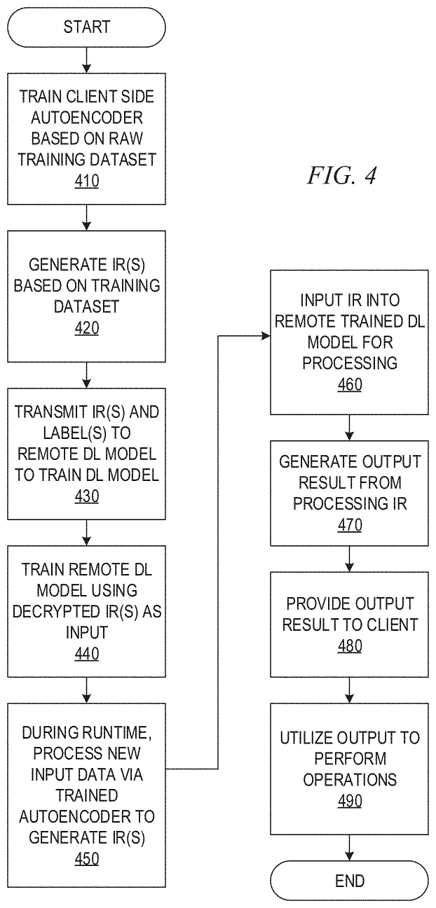

FIG. 4 is a flowchart outlining an example operation for training and utilizing a deep learning cloud computing service in accordance with one illustrative embodiment. As shown in FIG. 4, the operation starts by training a client side autoencoder based on raw training data so that the client side autoencoder generates appropriate intermediate representations (IRs) of input data (step 410). Having trained the autoencoder, an input training dataset is provided to the autoencoder to generate training dataset IRs (step 420). The training dataset IRs along with ground truth data are transmitted to the remote DL model (step 430) to thereby train the DL model to properly classify the training dataset IRs (step 440).

During runtime operation, new input data that is to be processed by the trained DL model, now executing on the deep learning cloud service computing system, is processed via the trained autoencoder to generate corresponding IRs which are then transmitted/uploaded to the deep learning cloud service framework (step 450). The deep learning cloud service computing system inputs the IRs into the trained DL model for processing (step 460). The trained DL model generates an output result based on the processing of the IR corresponding to the new input data (step 470) and provides the encrypted output result to the client (step 480) which may utilize the output to perform other operations at the client computing device (step 490). Alternatively, or in addition, as mentioned previously, the generated output may be provided to a cognitive computing system, which may implement one or more processing pipelines as described above, which performs a cognitive operation based on the output result generated by the trained DL model. The results of the cognitive operation may then be returned to the client computing device where the results of the cognitive operation may then be output and/or utilized to perform other operations. The operation then terminates.

Thus, the illustrative embodiments provide a privacy enhancing deep learning or AI cloud service framework that maintains the confidentiality of an end user's input data by providing mechanisms that permit the training and utilization of a remotely located DL model without exposing the raw input data (either training or runtime input data). It is to be understood that although this disclosure includes a detailed description of embodiments of the present invention being implemented on cloud computing systems, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics of a cloud model are as follows:

(1) On-demand self-service: a cloud consumer can unilaterally provision computing capabilities, such as server time and network storage, as needed automatically without requiring human interaction with the service's provider.

(2) Broad network access: capabilities are available over a network and accessed through standard mechanisms that promote use by heterogeneous thin or thick client platforms (e.g., mobile phones, laptops, and PDAs).

(3) Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

(4) Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

(5) Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

(1) Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

(2) Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

(3) Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

(1) Private cloud: the cloud infrastructure is operated solely for an organization. It may be managed by the organization or a third party and may exist on-premises or off-premises.

(2) Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

(3) Public cloud: the cloud infrastructure is made available to the general public or a large industry group and is owned by an organization selling cloud services.

(4) Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

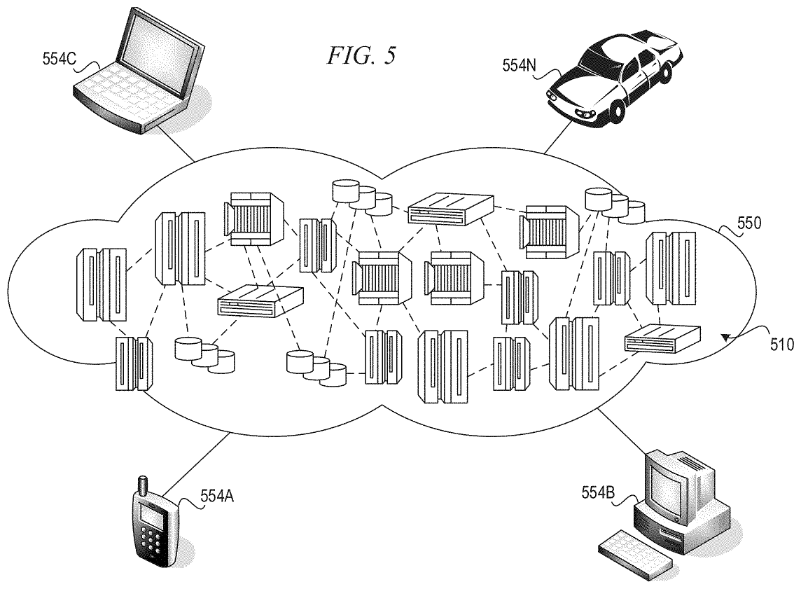

Referring now to FIG. 5, illustrative cloud computing environment 550 is depicted. As shown, cloud computing environment 550 includes one or more cloud computing nodes 510 with which local computing devices used by cloud consumers, such as, for example, personal digital assistant (PDA) or cellular telephone 554A, desktop computer 554B, laptop computer 554C, and/or automobile computer system 554N may communicate. Nodes 510 may communicate with one another. They may be grouped (not shown) physically or virtually, in one or more networks, such as Private, Community, Public, or Hybrid clouds as described hereinabove, or a combination thereof. This allows cloud computing environment 550 to offer infrastructure, platforms and/or software as services for which a cloud consumer does not need to maintain resources on a local computing device. It is understood that the types of computing devices 554A-N shown in FIG. 5 are intended to be illustrative only and that computing nodes 510 and cloud computing environment 550 can communicate with any type of computerized device over any type of network and/or network addressable connection (e.g., using a web browser).

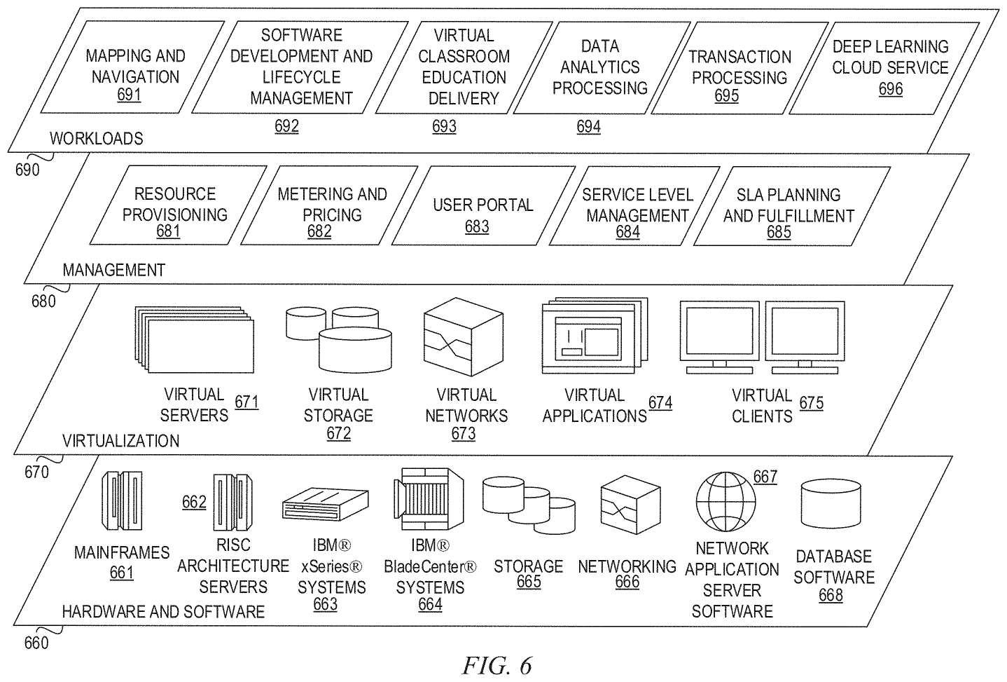

Referring now to FIG. 6, a set of functional abstraction layers provided by cloud computing environment 550 in FIG. 5 is shown. It should be understood in advance that the components, layers, and functions shown in FIG. 6 are intended to be illustrative only and embodiments of the invention are not limited thereto. As depicted, the following layers and corresponding functions are provided:

(1) Hardware and software layer 660 includes hardware and software components. Examples of hardware components include: mainframes 661; RISC (Reduced Instruction Set Computer) architecture based servers 662; servers 663; blade servers 664; storage devices 665; and networks and networking components 666. In some embodiments, software components include network application server software 667 and database software 668.

(2) Virtualization layer 670 provides an abstraction layer from which the following examples of virtual entities may be provided: virtual servers 671; virtual storage 672; virtual networks 673, including virtual private networks; virtual applications and operating systems 674; and virtual clients 675.

In one example, management layer 680 may provide the functions described below. Resource provisioning 681 provides dynamic procurement of computing resources and other resources that are utilized to perform tasks within the cloud computing environment. Metering and Pricing 682 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 683 provides access to the cloud computing environment for consumers and system administrators. Service level management 684 provides cloud computing resource allocation and management such that required service levels are met. Service Level Agreement (SLA) planning and fulfillment 685 provide pre-arrangement for, and procurement of, cloud computing resources for which a future requirement is anticipated in accordance with an SLA.

Workloads layer 690 provides examples of functionality for which the cloud computing environment may be utilized. Examples of workloads and functions which may be provided from this layer include: mapping and navigation 691; software development and lifecycle management 692; virtual classroom education delivery 693; data analytics processing 694; transaction processing 695; and deep learning cloud computing service processing 696. The deep learning cloud computing service processing 696 may comprise the pipelines and enhanced privacy cloud computing service framework previously described above with regard to one or more of the described illustrative embodiments.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a communication bus, such as a system bus, for example. The memory elements can include local memory employed during actual execution of the program code, bulk storage, and cache memories which provide temporary storage of at least some program code in order to reduce the number of times code must be retrieved from bulk storage during execution. The memory may be of various types including, but not limited to, ROM, PROM, EPROM, EEPROM, DRAM, SRAM, Flash memory, solid state memory, and the like.

Input/output or I/O devices (including but not limited to keyboards, displays, pointing devices, etc.) can be coupled to the system either directly or through intervening wired or wireless I/O interfaces and/or controllers, or the like. I/O devices may take many different forms other than conventional keyboards, displays, pointing devices, and the like, such as for example communication devices coupled through wired or wireless connections including, but not limited to, smart phones, tablet computers, touch screen devices, voice recognition devices, and the like. Any known or later developed I/O device is intended to be within the scope of the illustrative embodiments.

Network adapters may also be coupled to the system to enable the data processing system to become coupled to other data processing systems or remote printers or storage devices through intervening private or public networks. Modems, cable modems and Ethernet cards are just a few of the currently available types of network adapters for wired communications. Wireless communication based network adapters may also be utilized including, but not limited to, 802.11 a/b/g/n wireless communication adapters, Bluetooth wireless adapters, and the like. Any known or later developed network adapters are intended to be within the spirit and scope of the present invention.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for executing a trained deep learning (DL) model on a deep learning service computing system, the method comprising:
receiving, by the deep learning service computing system, from a trained autoencoder executing on a client computing device, one or more intermediate representation (IR) data structures corresponding to training input data input to the trained autoencoder;
training the DL model, executing on the deep learning service computing system, to generate a correct output based on the IR data structures from the trained autoencoder, to thereby generate a trained DL model;
receiving, by the deep learning service computing system, from the trained autoencoder executing on the client computing device, a new IR data structure corresponding to new input data input to the trained autoencoder;
inputting the new IR data structure to the trained DL model executing on the deep learning service computing system, to generate output results for the new IR data structure; and
generating, by the deep learning computing system, an output response based on the output results, which is transmitted to the client computing device.

2. The method of claim 1, further comprising:
training the autoencoder executing on the client computing device to generate intermediate representation (IR) data structures corresponding to input data input to the autoencoder, to thereby generate the trained autoencoder, wherein the new input data is processed by the trained autoencoder to generate the new IR data structure.

3. The method of claim 2, wherein training the autoencoder comprises:
iteratively modifying weights associated with nodes of layers of the autoencoder until a discrepancy between the training input data and outputs generated by the autoencoder are minimized to a predetermined level.

4. The method of claim 1, wherein the one or more IR data structures are intermediate representations of the training input data input to the trained autoencoder, obtained from an intermediate layer of the autoencoder.

5. The method of claim 4, wherein the intermediate layer of the autoencoder from which the one or more IR data structures are obtained is a last encoding layer of the autoencoder where one or more subsequent intermediate layers are decoding layers.

6. The method of claim 1, wherein training the DL model to generate a correct output based on the IR data structures from the trained autoencoder comprises:
receiving, by the deep learning service computing system, along with the one or more IR data structures, one or more ground truth labels for the training input data specifying a correct output of the DL model;
comparing, by training logic of the deep learning service computing system, an output generated by the DL model in response to inputting a portion of the training input data, to a ground truth label, in the received one or more ground truth labels, corresponding to the portion of the training input data; and
modifying, by the training logic of the deep learning service computing system, one or more weight values associated with one or more nodes of one or more layers of the DL model based on results of the comparing.

7. The method of claim 6, wherein modifying the one or more weight values comprises modifying the one or more weight values to minimize a loss function of the DL model.

8. The method of claim 1, wherein the deep learning service computing system is a deep learning cloud service comprising a plurality of server computing devices that are remotely located from the client computing device via at least one data communication network.

9. The method of claim 1, wherein the deep learning service computing system comprises a cognitive computing system, and wherein generating the output response comprises:
inputting the output results to the cognitive computing system to perform a cognitive computing operation based on the output results from the trained DL model; and
generating the output response based on results of the execution of the cognitive operation on the output results from the trained DL model.

10. The method of claim 1, wherein the new input data is new image data, the trained DL model is trained to classify image data into one of a plurality of different classifications of image data, the output result is a vector output in which each vector slot of the vector output corresponds to one of the different classifications of image data in the plurality of different classifications of image data, and values stored in each vector slot specify a probability that the corresponding classification of image data is a correct classification for the new image data.

11. A computer program product comprising a computer readable storage medium having a computer readable program stored therein, wherein the computer readable program, when executed in a deep learning service computing system, causes the deep learning service computing system to execute a trained deep learning (DL) model on the deep learning service computing system, at least by:
receiving, from a trained autoencoder executing on a client computing device, one or more intermediate representation (IR) data structures corresponding to training input data input to the trained autoencoder;
training a DL model to generate a correct output based on the IR data structures from the trained autoencoder, to thereby generate the trained DL model;
receiving from the trained autoencoder executing on the client computing device, a new IR data structure corresponding to new input data input to the trained autoencoder;
inputting the new IR data structure to the trained DL model executing on the deep learning service computing system, to generate output results for the new IR data structure; and
generating, by the deep learning computing system, an output response based on the output results, which is transmitted to the client computing device.

12. The computer program product of claim 11, wherein the computer readable program further causes the client computing device to:
train the autoencoder executing on the client computing device to generate intermediate representation (IR) data structures corresponding to input data input to the autoencoder, to thereby generate the trained autoencoder, wherein the new input data is processed by the trained autoencoder to generate the new IR data structure.

13. The computer program product of claim 12, wherein training the autoencoder comprises:
iteratively modifying weights associated with nodes of layers of the autoencoder until a discrepancy between the training input data and outputs generated by the autoencoder are minimized to a predetermined level.

14. The computer program product of claim 11, wherein the one or more IR data structures are intermediate representations of the training input data input to the trained autoencoder, obtained from an intermediate layer of the autoencoder.

15. The computer program product of claim 14, wherein the intermediate layer of the autoencoder from which the one or more IR data structures are obtained is a last encoding layer of the autoencoder where one or more subsequent intermediate layers are decoding layers.

16. The computer program product of claim 11, wherein the computer readable program further causes the deep learning service computing system to train the DL model to generate a correct output based on the IR data structures from the trained autoencoder at least by:
receiving, by the deep learning service computing system, along with the one or more IR data structures, one or more ground truth labels for the training input data specifying a correct output of the DL model;
comparing, by training logic of the deep learning service computing system, an output generated by the DL model in response to inputting a portion of the training input data, to a ground truth label, in the received one or more ground truth labels, corresponding to the portion of the training input data; and
modifying, by the training logic of the deep learning service computing system, one or more weight values associated with one or more nodes of one or more layers of the DL model based on results of the comparing.

17. The computer program product of claim 16, wherein modifying the one or more weight values comprises modifying the one or more weight values to minimize a loss function of the DL model.

18. The computer program product of claim 11, wherein the deep learning service computing system is a deep learning cloud service comprising a plurality of server computing devices that are remotely located from the client computing device via at least one data communication network.

19. The computer program product of claim 11, wherein the deep learning service computing system comprises a cognitive computing system, and wherein the computer readable program further causes the deep learning service computing system to generate the output response at least by:
inputting the output results to the cognitive computing system to perform a cognitive computing operation based on the output results from the trained DL model; and
generating the output response based on results of the execution of the cognitive operation on the output results from the trained DL model.

20. A deep learning service computing system, comprising:
at least one processor; and
at least one memory coupled to the at least one processor, wherein the at least one memory comprises instructions which, when executed by the at least one processor, cause the at least one processor to execute a trained deep learning (DL) model on the deep learning service computing system, at least by:
receiving, from a trained autoencoder executing on a client computing device, one or more intermediate representation (IR) data structures corresponding to training input data input to the trained autoencoder;
training a DL model to generate a correct output based on the IR data structures from the trained autoencoder, to thereby generate the trained DL model;
receiving from the trained autoencoder executing on the client computing device, a new IR data structure corresponding to new input data input to the trained autoencoder;
inputting the new IR data structure to the trained DL model executing on the deep learning service computing system, to generate output results for the new IR data structure; and
generating, by the deep learning computing system, an output response based on the output results, which is transmitted to the client computing device.
